(19) United States
(12) Patent Application Publication
(10) Pub. No.: US 2015/0206053 A1
(43) Pub. Date: Jul. 23, 2015

(54) COMPUTING SYSTEM WITH COMPREHENSIVE SENSOR MECHANISM AND METHOD OF OPERATION THEREOF

(71) Applicant: Samsung Electronics Co., Ltd., Gyeonggi-Do (KR)

(72) Inventor: Katherine Marie Hayden, Sunnyvale, CA (US)

(73) Assignee: Samsung Electronics Co., Ltd., Gyeonggi-Do (KR)

(21) Appl. No.: 14/160,318

(22) Filed: Jan. 21, 2014

(51) Int. Cl. G06N 5/02

(52) U.S. Cl. CPC G06N 5/02

(57) ABSTRACT

A method of operation of a computing system includes: receiving data from multiple sources; creating a profile based on the data received from the multiple sources; and predicting, with a control unit, an affective state with the profile based on the data received from the multiple sources.

### TECHNICAL FIELD

An embodiment of the present invention relates generally to a computing system and more particularly to a system with sensors.

### BACKGROUND

Modern consumer and industrial electronics, especially devices such as graphical computing systems, televisions, projectors, cellular phones, portable digital assistants, and combination devices, are providing increasing levels of functionality to support modern life. Research and development in the existing technologies can take a myriad of different directions.

These electronic devices are increasing “smart” by providing utility for users and particularly mobile users. The “smart” utilities are for the most part provided by applications installed on the “smart” devices. The applications are focused on specific information within subject-matter bounded data and application bounded data to provide “smart” information.

These applications for the “smart” devices can provide user customization that performs a defined task when a specific condition is reached such as an email when particular shoes become available in a specific size or when a plane ticket price reaches a specific limit. Other applications can include reinforcement learning systems such as music services can attempt to only play songs by discerning the musical features of songs given a thumbs up or thumbs down. Yet other applications can include demographic research on network effects on individual behavior.

These “smart” devices and applications are scope and context limited to specific tasks and conditions. By design, the devices and applications provide users with discrete functions for customization by each individual user. The customization and variability of users and devices also drives a need for simplified user interfaces and limited resources utilization, thus eliminating a comprehensive scope or context of the applications.

Thus, a need still remains for an electronic system with a comprehensive sensor mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system including: a source module implemented in a communication unit configured to receive data from multiple sources; a model module implemented in a storage unit, coupled to the communication unit, configured to create a profile based on the data received from the multiple sources; and a prediction module implemented in a control unit, coupled to the storage unit, configured to predict an affective state with the profile based on the data received from the multiple sources.

An embodiment of the present invention provides a method of operation of a computing system including: receiving data from multiple sources; creating a profile based on the data received from the multiple sources; and predicting, with a control unit, an affective state with the profile based on the data received from the multiple sources.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with image conversion mechanism in an embodiment of the present invention.

FIG. 2 is an exemplary block diagram of the computing system.

FIG. 3 is a control flow of the computing system.

FIG. 3 is the control flow with additional detail for the data module.

FIG. 4 is the control flow with additional detail for the model module.

FIG. 6 is a flow chart of a method of operation of a computing system in an embodiment of the present invention.

### DETAILED DESCRIPTION

In an embodiment of the present invention a prediction module coupled to a source module, and a data module can incorporate predictive modeling of behavior with real-time data sensing. The profiles or models of a model module over time can identify activities, interactions, or events that correlate with certain mood states and propose causes of these states that can be used for predictive purposes of the prediction module. The profiles or models of the model module over time can be more accurate with misleading readings balanced out by other correlating readings of the source module coupled to the data module.

The data module coupled to the source module and the model module can provide classification of at least image data, speech data, motion data, position data, or combination thereof to determine facial expression, speech analysis, gestures, activities, or combination thereof. The data module coupled to the source module and the model module can provide higher resolution of determining affective state or mood, at least because of real-time tracking of changes in the data, corroboration of frequent changes from multiple data sources, redundant data of the data, and multiple data sources.

The model module coupled to the data module and the prediction module can map user-labeled descriptions to system-detected moods or affective state for more precise mood or affective state determinations or predictions particularly with a longer observation history. The model module coupled to the data module and the prediction module can include a combination of module results to determine or predict the mood or the affective state with high resolution and high accuracy unattainable by a single model.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

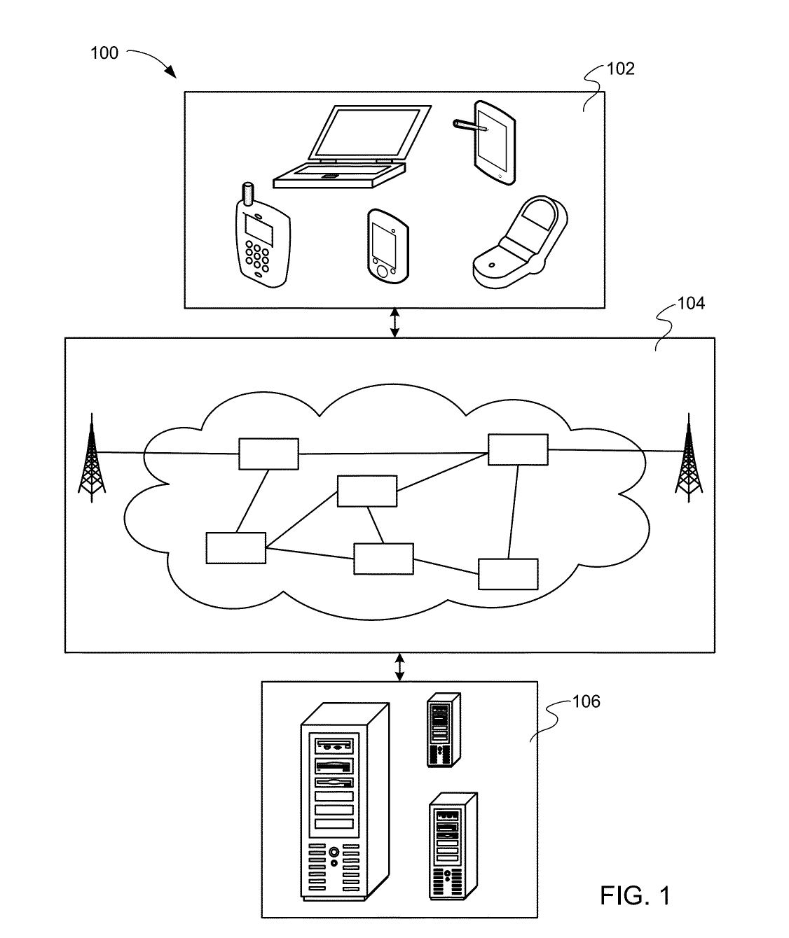

Referring now to FIG. 1, therein is shown a computing system 100 with image conversion mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the computing system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

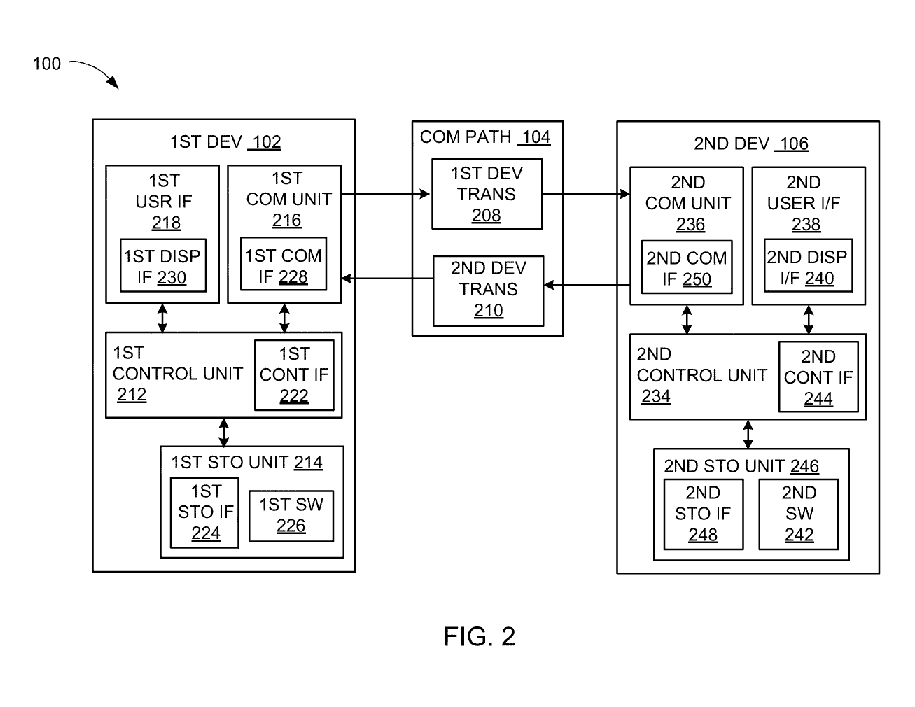

Referring now to FIG. 2, therein is shown an exemplary block diagram of the computing system 100. The computing system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the computing system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 102. For example, the first communication unit 216 can permit the first device 102 to communicate with the second device 106 of FIG. 1, an attachment, such as a peripheral device or a computer desktop, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include a display, a projector, a video screen, a speaker, or any combination thereof.

The first control unit 212 can operate the first user interface 218 to display information generated by the computing system 100. The first control unit 212 can also execute the first software 226 for the other functions of the computing system 100. The first control unit 212 can further execute the first software 226 for interaction with the communication path 104 via the first communication unit 216.

The second device 106 can be optimized for implementing an embodiment of the present invention in a multiple device embodiment with the first device 102. The second device 106 can provide the additional or higher performance processing power compared to the first device 102. The second device 106 can include a second control unit 234, a second communication unit 236, and a second user interface 238.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the computing system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the computing system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is external to the second device 106.

The second controller interface 244 can receive information from the other functional units or from external sources, or can transmit information to the other functional units or to external destinations. The external sources and the external destinations refer to sources and destinations external to the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the computing system 100 is shown with the second storage unit 246 as a single hierarchy storage system, although it is understood that the computing system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The computing system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the computing system 100.

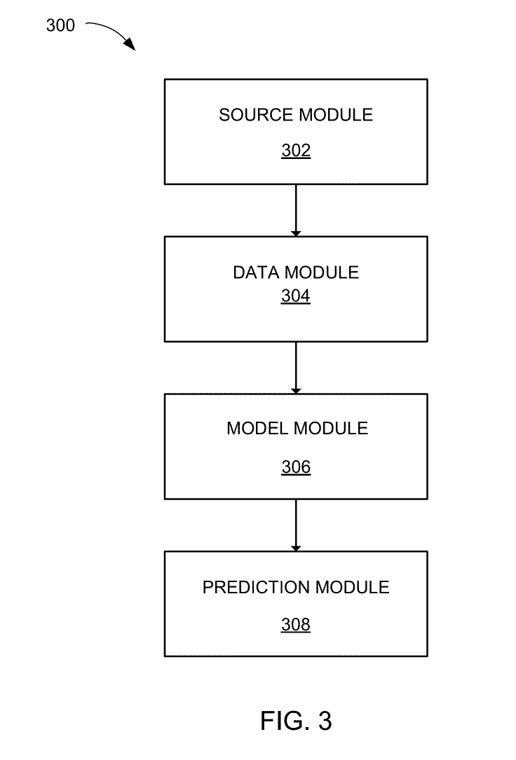

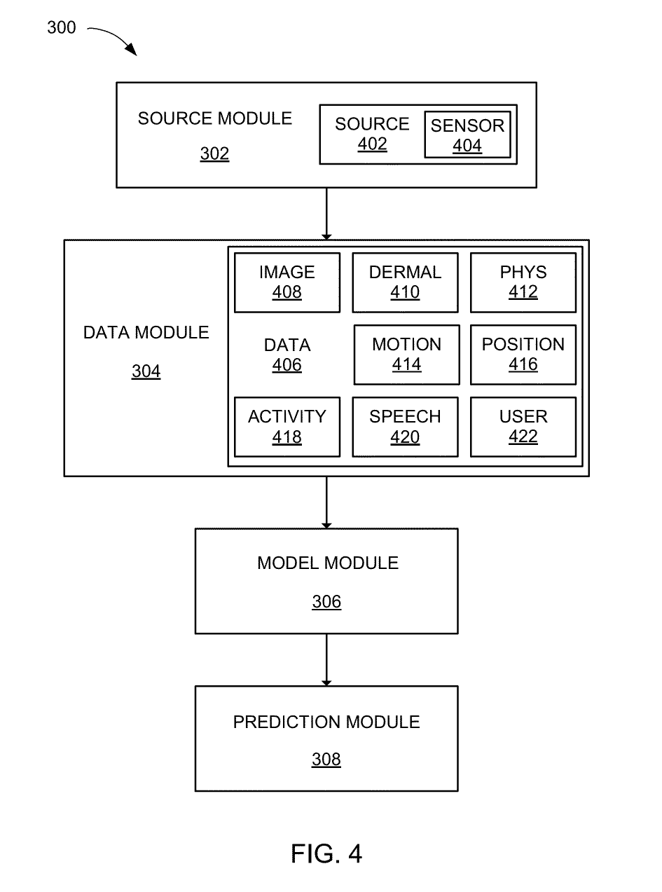

Referring now to FIG. 3, therein is shown a control flow 300 of the computing system 100. A source module 302 can be coupled to a data module 304, a model module 306, a prediction module 308, or combination thereof. The source module 302 preferable captures or receives affective data from multiple data sources 402 for the data module 304. The model module 306 can provide an affective profile or model with at least this affective data.

Affective computing can include an interdisciplinary field which incorporates artificial intelligence (AI), human computer interaction (HCl), psychology, and cognitive science. Affective computing has at least a goal of allowing automated understanding of human emotion.

The computing system 100 can integrate sensor data from multiple data sources 402 of the source module 302 coupled to the data module 304 including affective data to determine a user mood with accuracy and precision that exceeds the sum of the capabilities of each individual sensor such as those in the source module 302 including affective sensors.

The model module 306 can create individual and representative mood profiles or models by including demographic mood profiles or models based on configurations of all available affective measurements such as those of the source module 302 coupled to the data module 304 including simultaneous affective measurements.

The model module 306 can provide a model or profile for a mood or affective state based on categorization, dictionaries, templates, or combination thereof, of data. The model or profile can represent the mood or affective state quantitatively or qualitatively. For example, qualitative labels or categories can include “surprised”, and quantitative labels or categories can include coordinates in an affective model such as a valence arousal space. The model module 306 will be further described in the description of FIG. 5.

The prediction module 308 can apply profiles or models of the model module 306 to current data of the senor module 302 coupled to the data module 304 to predict an affective state. The affective state predicted by the prediction module 308 can be correlated to current data including user activity, user image, user communication, or combination thereof, from the source module 302 coupled to the data module 304.

The prediction module 308 coupled to the model module 306 and the data module 304 can predict possible upcoming moods or the affective state based on frequent patterns in data across sensors. For example, increased lethargy and slumped body posture precedes lower speech rate and lower pitch discontinuity, and eventually a user-labeled “depressed” mood or affective state. The prediction module 308 will be further described in the description of FIG. 5.

The computing system 100 can benefit from continuous and simultaneous measurement of a wide range of affective data of the senor module 302 coupled to the data module 304. The continuous and simultaneous measurements can allow for more sophisticated and precise mood profiles or models of the model module 306. These mood profiles or models can be more accurate, since noisy or misleading readings from one data source 402 of the source module 302 coupled to the data module 304 can be balanced out or compensated for by other correlating readings of other data sources 402 also of the source module 302 coupled to the data module 304.

For example, the data module 304 can include facial expressions, body posture, activity, gestures, speech affect, speech prosody, text, transcribed speech, text data sentiment analysis, galvanic skin response, heart rate, temperature, other physiological data, or combination thereof.

Also for example the model module 306 can include some or all of real-time tracking of changes with a frequency for relevant measurements, corroboration of frequent changes from multiple data sources improving resolution of determining affective state or mood, redundant simultaneous data sources and data types for cross-validation including discounting noisy signals.

It has been discovered that the prediction module 308 coupled to the source module 302, and the data module 304 can incorporate predictive modeling of behavior with real-time data sensing.

Further, it has been discovered that the profiles or models of the model module 306 over time can identify activities, interactions, or events that correlate with certain mood states and propose causes of these states that can be used for predictive purposes of the prediction module 308.

Yet further, it has been discovered that the profiles or models of the model module 306 over time are more accurate with misleading readings balanced out by other correlating readings of the source module 302 coupled to the data module 304.

The computing system 100 has been described with module functions or order as an example. The computing system 100 can partition the modules differently or order the modules differently. For example, the model module 306 can include the data module 304 and the source module 302 as separate modules although these modules can be combined into one. Also, the data module 304 can be split into separate modules for implementing in the separate modules each of the different data types or sources 402. Similarly the model module 306 can be split into separate modules for each model implementation.

The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

The source module 302 can be implemented as hardware in the first user interface 218, the second user interface 238, the first communication unit 216, the second communication unit 236, or combination thereof. The data module 304 can be implemented as hardware in the first storage unit 214, the second storage unit 246, or combination thereof. The model module can be implemented as hardware in the first storage unit 214, the second storage unit 246, the first control unit 216, the second control unit 236, or combination thereof. The prediction module 308 can be implemented as hardware in the first control unit 216, the second control unit 236, or combination thereof.

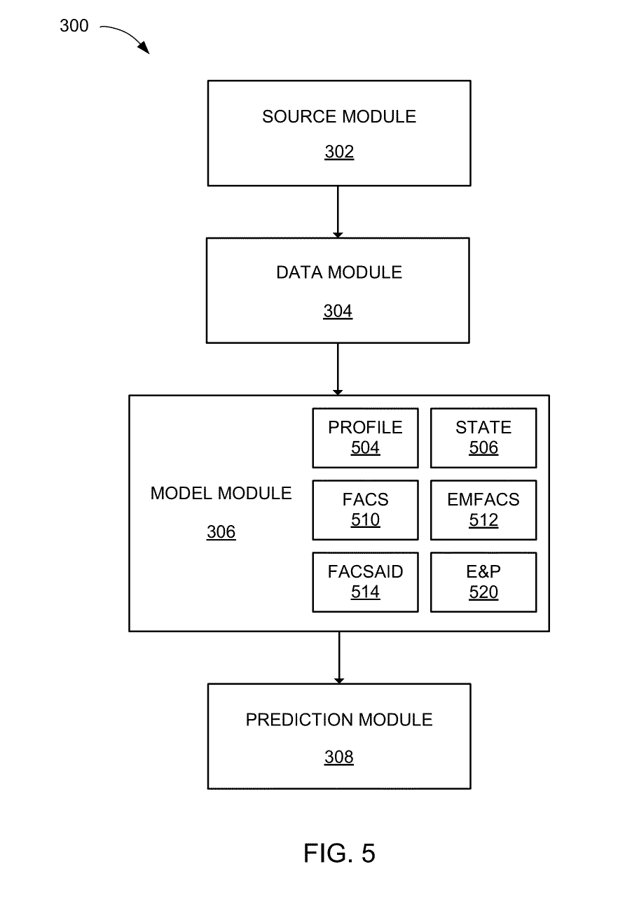

Referring now to FIG. 4, therein is shown the control flow 300 with additional detail for the data module 304. The data module 304 can be coupled to the source module 302, the model module 306, the prediction module 308, or combination thereof. The source module 302 provides data sources 402, which can include a sensor 404. Multiple data sources 402 can include multiple sensors 404 for providing data 406 to the data module 304.

The data module 304, the model module, or combination thereof can interpret data 406 including affective data for classification or recognition. The data 406 can be classified and stored by the data module 304 based on source, usage, association, activity, environment, mood, or combination thereof. The data module 304 coupled to the source module 302 and the model module 306 can integrate sensor data including affective data to determine a user mood with accuracy and precision that exceeds the sum of the capabilities of each individual sensor including affective sensors.

The data sources 402 of the source module 302 include but are not limited to facial expression recognition determined based on image data 408, galvanic skin response determined based on dermal data 410, electrodermal activity determined based on the dermal data 410, heart rate 412 determined based on physiological data 412, any other sensors 404, video determined based on image data 408, or combination thereof to collect motion determined based on motion data 414 or position determined based on position data 416 for individual parts of the body (e.g. foot versus hand movement or placement) that can show gestures and posture. The multiple data sources 402 of the source module 302 can also include activity determined based on activity data 418, speech affect determined based on speech data 420, speech prosody determined based on speech data 420, transcribed speech analysis determined based on speech data 420, textual sentiment analysis determined based on speech data 420, explicitly-given user data 422 on mood and physical state, or combination thereof.

Sensor for physiological measurement, biosensors, include Galvanic skin response (GSR) sensors or electrodermal activity sensors, such as a Q Sensor worn on a user wrist, can stream or periodically log readings. These biosensors can provide non-invasive measurements the physiological data 412 for a user including skin conductance, temperature, moisture, other surface changes, or combination thereof.

The data module 304 coupled to the model module 306 can provide body posture of the position data 416 or activity recognition of the activity data 418 using a combination of accelerometers and global positioning system (GPS) features. The activity recognition of the activity data 418 can be further augmented with data from other of the sensors 404, such as gyroscopes. Recognized activities include at least walking, jogging, ascending stairs, descending stairs, sitting, standing, or combination thereof. Additional activities or more complex combinations of these activities can be learned including through supervised or unsupervised machine learning of the data 406.

For example, activities with more movement such as walking or running include a periodic activity pattern that is more pronounced and can be distinguished by amplitude, frequency, peaks, and profiles in x, y, z accelerometer data particularly over time. An appropriate classification technique can classify new activity data such as a J48 decision tree, logistic regression, other classification, or combination thereof.

Activity recognition or body posture recognition can be improved by augmenting data with data from built-in phone sensors, sensor data from additional devices including accelerometers worn on the wrist or other appendages, heart monitors to further distinguish activity by the physical effort expended as registered by increased heart rate, or combination thereof.

In a manner similar to recognition or posture recognition, gesture recognition can be based on similar data with less frequency. Gesture recognition can further be based on a user currently touching a device or within a specific time, such as thirty seconds, of touching the device.

The data module 304 coupled to the source module 302 and the model module 304 can provide speech affect and speech prosody data. The speech data 420 can be a complex combination of verbal data and non-verbal data. Both the verbal data and the non-verbal data can be required for speech recognition. The non-verbal data, such as extra-linguistic data, can require additional different sensors or data formats from the sensors or formats of verbal data.

Similarly written or transcribed text, such as representing speech of the speech data 420, can also include speech affects. These speech affects can be captured or received as punctuation, notes, non-verbal data, extra-linguistic data, or combination thereof. Sentiment analysis can be based on text data from the sources 402 such as text messages, email, note or to-do list programs, speech to text transcriptions, or combination thereof.

Sentiment analysis of text content can include keyword recognition. For example a dominance of adjectives such as “frustrated” or “upset”, can indicate a bad mood. Sentiment analysis of text content can include more sophisticated association or recognition of concepts and scenarios that can cause certain moods. For example, “stuck in traffic” can causes worry or anger.

The data module 304 coupled to the source module 302 and the model module 306 can cross reference readings or data from different sensors, different types of sensors, different time of sensor response, or combination thereof. The cross-reference can determine conditions with high or low confidence in mood detection, data anomalies, behavior anomalies, conflicts, or combination thereof. For example a conflict between data and posture can include a GSR reading or data indicating fear with a body posture indicating confidence.

It has been discovered that the data module 304 coupled to the source module 302 and the model module 306 provides classification of at least the image data 408, the speech data 420, the motion data 414, the position data 416, or combination thereof to determine facial expression, speech analysis, gestures, activities, or combination thereof.

Further it has been discovered that the data module 304 coupled to the source module 302 and the model module 306 provides higher resolution of determining affective state or mood, at least because of real-time tracking of changes in the data 406, corroboration of frequent changes from multiple data sources 402, redundant data of the data 406, and multiple data sources 402

Referring now to FIG. 5, therein is shown the control flow 300 with additional detail for the model module 306. The model module 306 can be coupled to the source module 302, the data module 304, the prediction module 308, or combination thereof, and can create a database, model, or profile of observed affective data 406 and propose correlations of the data 406 for comprehensive mood profiles or models.

The model module 306 can provide a model or a profile 504 for a mood or an affective state 506 based on categorization, dictionaries, templates, or combination thereof, of the data 406. The model or the profile 504 can represent the mood or the affective state 506 quantitatively or qualitatively such as entries describing the affective state 506 including mood, emotion, feelings, or combination thereof. For example, qualitative labels or categories can include “surprised”, and quantitative labels or categories can include coordinates in an affective model such as a valence arousal space.

For example, when a user exhibits an emotional response, the sensors can record the context. Over time the system identifies which are the constants in each scenario or context, and determines the specific constants to which the user responded. Further to the example, a certain loud noise or reappearance of a character in the scenes of a movie is associated with a particular emotional response.

The model module 306 can include a Facial Action Coding System (FACS) module 510, an Emotional Facial Action Coding System (EMFACS) module 512, a Facial Action Coding System Affect Interpretation Dictionary (FACSAID) module 514.

The model module 306 can measure the user's mood or affective state 506 in at least two ways including categorizing static images 408 using Facial Action Coding System “FACS” and deconstructing the image 408 into specific Action Units “AU” of muscles activated or categorizing video segments 408 using Essa and Pentland's templates for whole-face analysis of facial dynamics in motion using a spatio-temporal motion energy model, potentially more accurate but more resource-intensive.

As an example, using FACS, an agreed upon AU categorizations for emotions can include “happiness” with an AU of 6+12, “sadness” with an AU of 1+4+15, or “surprise” with an AU of 1+2+5B+26. Further, a subset of FACS could be also be implemented such as Emotional Facial Action Coding System “EMFACS” or Facial Action Coding System Affect Interpretation Dictionary “FACSAID” that considers only emotion-related facial actions.

The model module 306 can also include an Essa and Pentland module 520. The Essa and Pentland module 520 can use Essa and Pentland's templates with a similarity score that can be computed of a captured or received expression with a corrected facial motion energy template including templates for smile, surprise, raised eye brow, anger, and disgust.

As an example, an AU can be extracted of a face from video sequences by generating a finite element mesh “FEM” over a face, and reducing the mesh into a 2D spatio-temporal motion energy representation to compare to expression templates. A Euclidean norm of the difference between two captured or received faces or expressions can be implemented to measure the similarity or dissimilarity.

The model module 306 with the profile 504 for determining the affective state 506 can include a combination of modules and module results. The FACS module 510, the EMFACS module 512, the FACSAID module, and the Essa and Pentland module 520, can be executed in any combination or sequence to determine or predict the mood or the affective state 506. The combination of modules and module results can provide higher resolution and higher accuracy than a single module for determining or predicting the mood or the affective state 506.

The model module 306 coupled to data module 304 and the prediction module 308 can predict possible upcoming moods or the affective state 506 based on frequent patterns in data 406 across the sensors 404. For example, increased lethargy and slumped body posture precedes lower speech rate and lower pitch discontinuity, and eventually a user-labeled “depressed” mood or affective state 506.

It has been discovered that the model module 306 coupled to the data module 304 and the prediction module 308 can map user-labeled descriptions to system-detected moods or affective state 506 for more precise mood or affective state 506 determinations or predictions particularly with a longer observation history.

Further it has been discovered that the model module 306 coupled to data module 304 and the prediction module 308 can include a combination of module results to determine or predict the mood or the affective state 506 with high resolution and high accuracy unattainable by a single model.

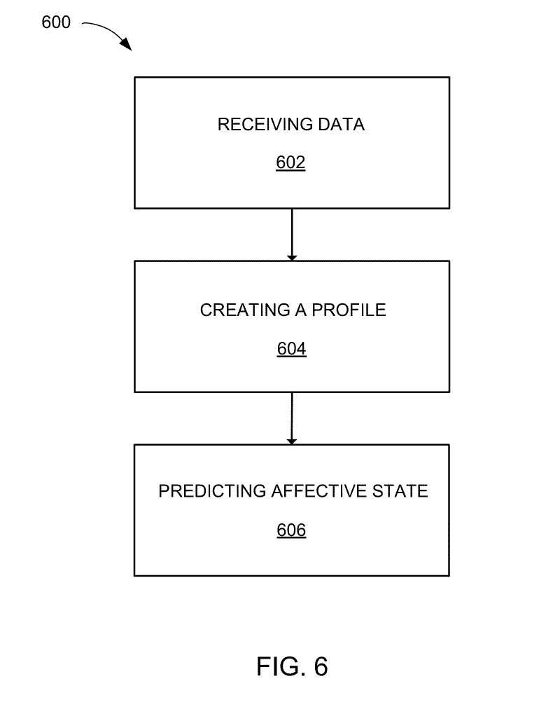

Referring now to FIG. 6, therein is shown a flow chart of a method 600 of operation of a computing system 100 in an embodiment of the present invention. The method 600 includes: receiving data from multiple sources in a block 602; creating a profile based on the data received from the multiple sources in a block 604; and predicting, with a control unit, an affective state with the profile based on the data received from the multiple sources in a block 606.

Further, the prediction module coupled to the source module, and the data module can incorporate predictive modeling of behavior with real-time data sensing.

Yet further, the profiles or models of the model module over time can identify activities, interactions, or events that correlate with certain mood states and propose causes of these states that can be used for predictive purposes of the prediction module.

Yet further, the profiles or models of the model module over time are more accurate with misleading readings balanced out by other correlating readings of the source module coupled to the data module.

Yet further, the data module coupled to the source module and the model module provides classification of at least the image data, the speech data, the motion data, the position data, or combination thereof to determine facial expression, speech analysis, gestures, activities, or combination thereof.

Yet further, the data module coupled to the source module and the model module provides higher resolution of determining affective state or mood, at least because of real-time tracking of changes in the data, corroboration of frequent changes from multiple data sources, redundant data of the data, and multiple data sources.

Yet further, the model module coupled to data module and the prediction module can map user-labeled descriptions to system-detected moods or affective state for more precise mood or affective state determinations or predictions particularly with a longer observation history.

Yet further, the model module coupled to the data module and the prediction module can include a combination of module results to determine or predict the mood or the affective state with high resolution and high accuracy unattainable by a single model.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a source module implemented in a communication unit configured to receive data from multiple sources;
a model module implemented in a storage unit, coupled to the communication unit, configured to create a profile based on the data received from the multiple sources; and
a prediction module implemented in a control unit, coupled to the storage unit, configured to predict an affective state with the profile based on the data received from the multiple sources.

2. The system as claimed in claim 1 wherein the model module implemented in the storage unit includes creating the profile with facial action coding system (FACS) module.

3. The system as claimed in claim 1 wherein the model module implemented in the storage unit is configured to create the profile with an Essa and Pentland module.

4. The system as claimed in claim 1 wherein the model module implemented in the storage unit is configured to cross reference data.

5. The system as claimed in claim 1 wherein the model module implemented in the storage unit is configured to include user data to create the profile.

6. The system as claimed in claim 1 wherein the prediction module implemented in the control unit is configured to predict the affective state based on additional data.

7. The system as claimed in claim 1 wherein the source module implemented in the communication unit is configured to determine a facial expression based on image data.

8. The system as claimed in claim 1 wherein the source module implemented in the communication unit is configured to determining speech prosody based on speech data.

9. The system as claimed in claim 1 wherein the source module implemented in the communication unit is configured to determine a gesture based on position data.

10. The system as claimed in claim 1 wherein the source module implemented in the communication unit is configured to determine an activity based on activity data.

11. A method of operation of a computing system comprising:
receiving data from multiple sources;
creating a profile based on the data; and
predicting, with a control unit, an affective state with the profile.

12. The method as claimed in claim 11 wherein creating the profile includes creating the profile with facial action coding system (FACS) module

13. The method as claimed in claim 11 wherein creating the profile includes creating the profile with an Essa and Pentland module.

14. The method as claimed in claim 11 wherein creating the profile includes cross referencing data.

15. The method as claimed in claim 11 wherein creating the profile includes user data.

16. The method as claimed in claim 11 wherein predicting the affective state includes predicting the affective state based on additional data.

17. The method as claimed in claim 11 wherein receiving the data includes determining a facial expression based on image data.

18. The method as claimed in claim 11 wherein receiving the data includes determining speech prosody based on speech data.

19. The method as claimed in claim 11 wherein receiving the data includes determining a gesture based on position data.

20. The method as claimed in claim 16 receiving the data includes determining an activity based on activity data.
